(19) United States
(12) Patent Application Publication
(10) Pub. No.: US 2025/0021946 A1
(43) Pub. Date: Jan. 16, 2025

(54) VEHICLE SMART TAG

(71) Applicant: Polaris Industries Inc., Medina, MN (US)

(72) Inventors: Richard M. Cardinal, Ham Lake, MN (US); John A. Kastanek, Amery, WI (US)

(73) Assignee: Polaris Industries Inc., Medina, MN (US)

(21) Appl. No.: 18/711,215

(22) PCT Filed: Jul. 27, 2022
(86) PCT No.: PCT/US2022/038442

§ 371 Date: May 17, 2024

Related U.S. Application Data
(60) Provisional application No. 63/281,316, filed on Nov. 19, 2021.

(51) Int. Cl. G06Q 10/20; G06F 16/955; G06K 19/07; G06Q 30/0601

(52) U.S. Cl. CPC G06Q 10/20; G06F 16/955; G06K 19/0723; G06Q 30/0621; G06Q 30/0633; G06Q 30/0643

(57) ABSTRACT

A radio tag may be disposed on a vehicle, for example beneath a vehicle badge. The radio tag may include vehicle identification information, such that a computing device may be directed to a website based on the vehicle identification information accordingly. For example, a user may be presented with a vehicle-specific website having information associated with the vehicle. As another example, the vehicle identification information may be obtained from the radio tag and used to access additional information associated with the vehicle and/or generate a service record for servicing the vehicle. An accessory may include a similar radio tag, which may be scanned to access manuals or tutorials associated with the accessory. The accessory radio tag may be used in combination with a vehicle radio tag to associate the accessory with the vehicle. In another example, an accessory radio tag may be used to register a warranty of the accessory.

### RELATED APPLICATIONS

The present disclosure claims priority to U.S. Provisional Application No. 63/281,316, filed Nov. 19, 2021, titled VEHICLE SMART TAG, docket PLR-00TC-29872.01P-US, the entire disclosure of which is expressly incorporated by reference herein.

### TECHNICAL FIELD

The present disclosure is related to computer-readable radio tags for obtaining vehicle, accessory, and/or other identification information.

### BACKGROUND

Vehicle identification information may be used by a vehicle operator, a dealer, or any of a variety of other users. However, identifying the vehicle identification information on a vehicle may be difficult, especially in instances where the vehicle identification information is not available in a consistent location across multiple vehicles or where environmental conditions may adversely affect the legibility of the vehicle identification information. Further, manually inputting the vehicle identification information may be tedious and introduce the potential for human error.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a smart vehicle tag, where a radio tag may be disposed on a vehicle, for example beneath a vehicle badge. A computing device may be used to scan the radio tag, for example by positioning the computing device in proximity to the vehicle badge. The radio tag may include a vehicle uniform resource locator (URL) that includes vehicle identification information, such that the computing device may be directed to a website based on the vehicle identification information accordingly. For example, a user may be presented with a vehicle-specific website having information associated with the vehicle, a pre-sales website enabling the user to customize a vehicle according to a variety of available options, or an experience website with trail information, terrain information, and/or safety training. As another example, the vehicle identification information may be obtained from the radio tag and used to access additional information associated with the vehicle and/or generate a service record for servicing the vehicle.

In some instances, an accessory may include a similar radio tag, which may be scanned and used to access manuals or tutorials associated with the accessory. The accessory radio tag may be used in combination with a vehicle radio tag to associate the accessory with the vehicle. In another example, an accessory radio tag may be used to register a warranty of the accessory. Thus, use of such radio tags may enable a user to easily obtain vehicle and/or accessory identification information and automatically perform associated processing to provide a variety of functionality.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which a vehicle smart tag may be used according to aspects described herein.

FIGS. 2A-2C illustrate example locations at which a vehicle smart tag may be positioned on a variety of vehicle types.

FIG. 3 illustrates an exploded view of an example vehicle smart tag according to aspects of the present disclosure.

FIG. 4A illustrates an overview of an example method for requesting information associated with a vehicle smart tag according to aspects described herein.

FIG. 4B illustrates an overview of an example method for processing a request for information associated with a vehicle smart tag according to aspects described herein.

FIG. 5A illustrates an overview of an example method for processing accessory radio tag information according to aspects described herein.

FIGS. 5B and 5C illustrate overviews of example methods for processing requests associated with accessory radio tag information according to aspects described herein.

FIG. 6A illustrates an overview of an example method for processing vehicle radio tag information in a vehicle service context according to aspects described herein.

FIG. 6B illustrates an overview of an example method for generating a service record based on vehicle radio tag information.

FIGS. 7A-7C illustrate overviews of example user interfaces according to aspects described herein.

FIG. 8 illustrates a diagram of a computing system for multi-vehicle communication and control.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a vehicle is associated with identification information that may encode or may be used to obtain any of a variety of information associated with the vehicle, such as model-specific information (e.g., a model year or associated features) and/or vehicle-specific information (e.g., a factory configuration of the vehicle, maintenance information, or safety/service information), among other examples. Example vehicle identification information includes, but is not limited to, a vehicle identification (VIN), a serial number, or a globally unique identifier (GUID). While vehicle identification information and accessory identification information is described as being unique to a given vehicle or accessory, respectively, it will be appreciated that, in other examples, such identification information need not uniquely identify the vehicle or accessory.

However, ensuring that vehicle identification information is physically disposed on the vehicle in a way that is durable and also easily accessible (e.g., by a vehicle operator, a dealer, or service professional) may be challenging, especially across various types of vehicles that may each be used in varying environmental conditions. Further, many techniques may trade accessibility for durability or vice versa, thereby resulting in user frustration or inaccessibility of the vehicle identification information as a result of insufficient lighting with which to view the vehicle identification information, obstruction of the vehicle identification information by mud, debris, and/or one or more accessories, or wear or damage to the location at which the vehicle identification information is disposed on the vehicle.

Accordingly, aspects of the present disclosure relate to a vehicle smart tag (which may also be referred to herein as a radio tag). In examples, vehicle identification information is included as part of a radio tag that is affixed to the vehicle. Example vehicles include, but are not limited to, utility vehicles and recreational vehicles. For example, a utility vehicle may be a low-speed vehicle (e.g., a golf cart), a lawn mower, or a fleet vehicle. As another example, a recreational vehicle may be an all-terrain vehicle (ATV), a side-by-side (SxS) vehicle, an off-road vehicle, a motorcycle, an open-air roadster, a snowmobile, or watercraft.

The radio tag may be affixed to the vehicle at a location that is easily accessible and/or identifiable by an operator or other user, for example beneath a hood emblem or other vehicle badge. In examples, the hood emblem or vehicle badge may include a recognizable icon or other feature that indicates to a user that the badge is usable to obtain vehicle identification information for the vehicle (e.g., by scanning the radio tag using a computing device). Further, such a location may protect the radio tag from environmental conditions. Additionally, use of a radio tag as compared to a barcode or a Quick Response (QR) code may improve accessibility to the vehicle identification information, as the radio tag may be less dependent on adequate lighting, focal length, and/or other conditions.

As a result of the vehicle identification information provided by a radio tag according to aspects described herein, a user may scan the radio tag using a computing device, which may provide a variety of resulting functionality. Example functionality is listed below and described in more detail herein, for example with respect to pre-ownership users, fleet owner/rental franchise users, (post-) ownership users (e.g., operators), and dealer users. While functionality is described with respect to a specific example user, it will be appreciated that functionality described herein need not be limited to a specific user type.

### Pre-Ownership User Experience

Build a vehicle and make optional customizations
See a use-specified build with pricing information (including a payment calculator)
View a three-dimensional (3D) model of a vehicle and/or associated accessories
Shop model options or explore an associated vehicle line up
Perform vehicle to vehicle comparisons
View vehicle features and benefits
View vehicle specifications
Obtain vehicle documentation and sales guides (e.g., “Help me Choose”)
Search Dealer inventory
View reviews
Present and receive user acceptance of test ride waivers
Obtain add-on pricing information (e.g., finance and insurance)
View special offers
View product catalogs
Access a shopping experience (Vehicles, Parts, Accessories, Clothing, and Gear)

### Ownership User Experience

Perform delivery acceptance
Perform owner registration
Provide access to new owner tutorials
Provide access to an owner user account
Add a vehicle to a user's owner account
Enable maintenance record management (e.g., recording, updating, and/or viewing)
Access a shopping experience for vehicle-specific parts, accessories, and maintenance-related items (e.g., service intervals and recommendations)
Access an accessory configurator experience (e.g., including accessory information and/or 3D representations of accessories individually and/or with an associated vehicle)
Access vehicle & accessory instructions
Access self-help resources and DIY support
Access vehicle- and/or accessory-specific manuals (e.g., owners/parts diagrams)
Access safety information
Access recall information (e.g., impact and status)
Access a dealer locator and other dealer information
Schedule service
Access special offers
View and/or add available protection and/or maintenance plans
Transfer ownership
Estimate trade value
Obtain customer support/view contact information
Access gamification features (e.g., geocaching or augmented reality events)
Location Services
Access relevant trail maps (e.g., choose a vehicle to see associated trails)
Perform component linking (e.g., associate an accessory and a vehicle)
Determine whether the vehicle has been marked stolen
Access a vehicle “birthmark”

### Fleet Owner/Rental Franchise User Experience

Complete a vehicle walk around to capture image/video data
Provide access to operation & safety training
Perform a check in & check out process
Perform waiver kickoff and completion
Enable experience and/or photo capture, for example to a customer account
Perform deductible and payment processing

### Dealer User Experience

Perform a unit inquiry (e.g., access a vehicle information portal)
Perform claim processing
Product quality reporting
Access vehicle set-up/build instructions
Access service/safety bulletin instructions/indicate service completion
Perform vehicle ordering/receiving
Capture and link vehicle photos to a vehicle
Manage vehicle maintenance records
Perform a customer information look-up
Perform a warranty & extended contract look-up
Access diagnostic support (e.g., with original equipment)
Access vehicle service reports/perform a health report look-up
Access to live vehicle data
Diagnostic trouble code look-up
Vehicle check-in/walk around (e.g., to capture image and/or video data)
Dealer management system integration
Diagnostic tool vehicle identifier
Inventory management
Product placement/inventory locator
Vehicle and/or accessory registration processing
Pre-delivery inspection and/or legal waiver acceptance
Service tracking updates, for example including push notifications
Provide sales assistant based on radio tag information
Lead capture & management

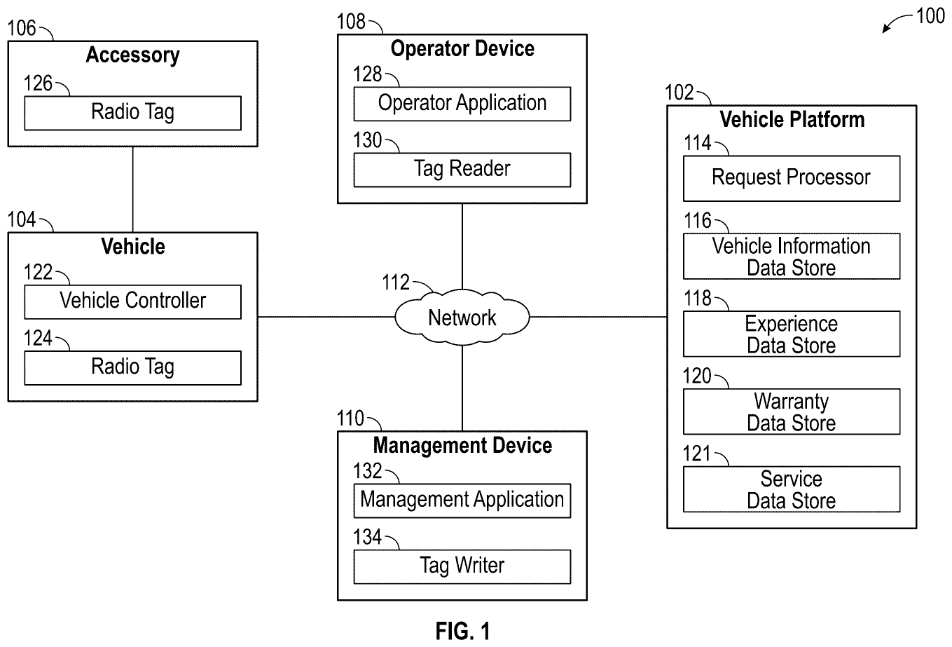

FIG. 1 illustrates an overview of an example system 100 in which vehicle smart tags may be used. As illustrated, system 100 includes vehicle platform 102, vehicle 104, accessory 106, operator device 108, and management device 110. Vehicle platform 102, vehicle 104, operator device 108, and management device 110 are illustrated as communicating via network 112, which may comprise a local area network, a wireless network, a cellular network, a satellite-based network, or the Internet, or any combination thereof, among other examples. For example, vehicle controller 122 of vehicle 104 may communicate with vehicle platform 102 using a cellular connection (e.g., via a cellular modem of vehicle controller 122 or via a wireless connection to operator device 108). As another example, operator device 108 or management device 110 may communicate with vehicle platform 102 using an Internet connection and may communicate with vehicle 104 using a Wi-Fi or Bluetooth connection.

Operator device 108 and management device 110 may each be any of a variety of computing devices, including, but not limited to, a tablet computing device, a mobile computing device, a laptop computing device, or a desktop computing device. In examples, operator device 108 is used by an operator of a vehicle (e.g., vehicle 104), though aspects described herein are similarly applicable to a computing device used by any of a variety of other users. Similarly, management device 110 may be used by a dealer or an experience provider, though the disclosed aspects are similarly applicable to a computing device used by any of a variety of other users.

Vehicle 104 is illustrated as comprising vehicle controller 122 and radio tag 124. In examples, vehicle controller 122 controls functionality of vehicle 104, for example relating to communications (e.g., with vehicle platform 102, accessory 106, operator device 108, management device 110, and/or one or more other vehicles), navigation and other location-related functionality (e.g., using a global positioning system (GPS) sensor or other location determiner), and/or vehicle movement. As an example, vehicle 104 may comprise one or more ground engaging members (not pictured), which are operatively coupled to power system of vehicle 104 that includes one or more power sources, such as a fuel tank, fuel cell, and/or one or more batteries. Vehicle controller 122 may control such a power system accordingly.

Radio tag 124 may be a near-field communication (NFC) tag or a Bluetooth low energy (BLE) beacon, among other examples. In examples, radio tag 124 is a programmable NFC tag, as may be programmed by tag writer 134 of management device 110. In such instances, radio tag 12 may be “locked” to prevent reprogramming by unauthorized devices (e.g., those other than management device 110 or other devices associated with vehicle platform 102). Radio tag 124 stores vehicle identification information according to aspects described herein. For example, tag reader 130 of operator device 108 may read radio tag 124 to obtain vehicle identification information stored therein. In examples, tag writer 134 is capable of both reading and writing radio tags. In some instances, radio tag 124 includes multiple entries such as, for example, vehicle identification information.

For example, a first entry may include a vehicle uniform resource locator (URL) to which vehicle identification information is appended, while a second entry of radio tag 124 includes only the vehicle identification information itself (e.g., a VIN, serial number, or GUID). Thus, the first entry of radio tag 124 may enable operator application 128 of operator device 108 to access a website (e.g., of vehicle platform 102) having information associated with vehicle 104 based on the appended VIN. For example, the website may include vehicle-specific information and/or model-specific information, such as information associated with a factory configuration of vehicle 104, vehicle safety/service information, and/or theft alerts, among other examples. Example safety/service information includes, but is not limited to, information associated with optional field actions or upgrades, as well as information associated with a recall. In examples, at least a part of such safety/service information may be dealer-facing (e.g., as may be provided to management device 110), such as a “dealer hold” indication (pre-retail), a “stop-sale” indication (pre-sale), and a “battery alert” indication (pre-sale). In examples, the first entry includes data that will invoke associated functionality at a computing device (e.g., opening a URL), while the second entry includes data usable by an application to perform subsequent processing (e.g., vehicle identification information itself).

As a result of radio tag 124 including the vehicle URL, vehicle platform 102 may redirect a request of operator application 128 in some examples. For example, operator application 128 may be redirected to a website having vehicle-specific information and/or to a model-specific information, among other examples. In some examples, vehicle-specific information is provided to operator application 128 when vehicle 104 is registered or otherwise associated with an operator, while operator application 128 may instead be directed to a pre-sales website when vehicle 104 is not registered. For example, the pre-sales website may enable a prospective buyer to access model-specific information, configure and/or order a vehicle, or view a 3D model of a vehicle (and, in some instances, one or more user-selected accessories), among other examples. Thus, the vehicle identification information obtained by tag reader 130 may be used by operator application 128 (in conjunction with vehicle platform 102, in some examples) to provide the example functionality described herein, for example relating to a Pre-Ownership User Experience and an Ownership User Experience.

As another example, vehicle identification information may be obtained from multiple vehicles, which may be used to associate the vehicles with one another. For instance, an operator may use operator device 108 to scan radio tags of each vehicle, such that a group may be formed that includes each of the scanned vehicles and/or associated operators. As an example, the operator device may provide vehicle identification information for each of the scanned vehicles to vehicle platform 102, which may identify associated operator profiles and generate the group accordingly. As another example, an indication of each operator may be provided to operator device 108 in response. Thus, aspects described herein may facilitate social functionality associated with vehicles, operator profiles, and/or vehicle platform 102, among other examples.

As another example, the second entry of radio tag 124 may be obtained by management application 132 to perform additional or alternative processing separate from the website, for example locally to management device 110 and/or in conjunction with vehicle platform 102, among other examples. As an example, management application 132 may obtain vehicle information and/or operator information (e.g., from vehicle platform 102), may enable a user of management device 110 to capture image and/or video data associated with vehicle 104 (e.g., as may be stored by vehicle platform 102), and/or may reprogram radio tag 124. The captured image and/or video data may be provided to vehicle platform 102, where it may be stored in association with vehicle identification information accordingly. For example, the images and/or videos may be provided to illustrate component information associated with the vehicle, as may be used to process a warranty claim.

As another example, management application 132 may be used to access a service manual, order a replacement part, and/or create or update a service record associated with vehicle 104 based on vehicle identification information of radio tag 124. Thus, the vehicle identification information obtained by tag writer 134 may be used by management application 132 (in conjunction with vehicle platform 102, in some examples) to provide the example functionality discussed above, for example relating to a Fleet Owner/Rental Franchise User Experience or a Dealer User Experience. Management application 132 may be a native application or a web-based application, or any combination thereof, among other examples.

In some examples, radio tag 124 may be programmed to include information associated with a dealer, a vehicle service center, or an experience provider (e.g., that rents a fleet of vehicles for use by one or more operators), among other examples. Such information may be in addition to or as an alternative to one or more entries of radio tag 124. For example, contact information, service information, and/or one or more associated URLs may be included. As a result, when an operator scans radio tag 124 using operator device 108, operator application 128 may display information associated with the dealer, the vehicle service center, and/or the experience provider. As another example, radio tag 124 may cause operator application 128 to obtain information associated with an experience, such as a trail map or terrain information. In some instances, operator application 128 may provide an interactive experience to a user of operator device 108, for example where a user completes safety training, views and executes a waiver, and/or evaluates a vehicle condition (e.g., by capturing image and/or video data or completing a series of questions). While operator device 108 is described in an example where such functionality is provided via one or more websites, it will be appreciated that similar techniques may be used where operator device 108 includes a native application.

It will be appreciated that a radio tag may include any number of entries. For example, dealer information may be programmed as a third entry or may be programmed in place of a first entry including a vehicle URL. Further, entries may have any of a variety of orderings. As an example, the first entry may include a URL (e.g., a vehicle URL or an experience URL), as the first entry may be automatically read by tag reader 130 of operator device 108, thereby causing operator application 128 to access the URL accordingly.

Further, while examples are described where a radio tag is programmed or re-programmed to include dealer information, vehicle service center information, and/or experience provider information, it will be appreciated that such information may additionally or alternatively be provided by vehicle platform 102, for example as part of a response to a request for a vehicle URL or a result of configuring a redirect for the vehicle URL by vehicle platform 102. In other examples, radio tag 124 need not include a separate entry having the vehicle identification information itself, as management application 132 may instead extract the vehicle identification information from a vehicle URL accordingly. While radio tag 124 is described as being reprogrammable, it will be appreciated that, in other examples, radio tag 124 may not be reprogrammable or may be controllable by vehicle controller 122.

System 100 is further illustrated as comprising accessory 106, which may be any of a variety of accessories for vehicle 104. As illustrated, accessory 106 is electrically and/or mechanically coupled to vehicle 104, though it will be appreciated that, in other examples, accessory 106 need not be coupled to vehicle 104.

Accessory 106 includes radio tag 126, aspects of which are similar to radio tag 124 discussed above and are therefore not necessarily re-described below in detail. For example, radio tag 126 stores accessory identification information, such as a serial number of a GUID, among other examples. In some instances, radio tag 126 includes an entry having an accessory URL, as may be used to obtain a manual, access a tutorial, or complete warranty registration associated with accessory 106 (e.g., using operator application 128 of operator device 108).

While aspects herein are described in examples where a vehicle and an accessory each have an associated radio tag, it will be appreciated that similar techniques may be applied to parts (e.g., of vehicle 104 or accessory 106) and wearable products (e.g., helmets, jackets, boots, and gloves, as well as other clothing and gear), among other examples. For instance, a part of vehicle 104 or accessory 106 may include a radio tag, such that the radio tag may be scanned and used to order a replacement or upgrade for the part (e.g., having higher performance characteristics or increased durability), or the radio tag may be used to order a consumable part associated therewith (e.g., more oil or a replacement air filter). Similarly, a radio tag may be used to access a manual, watch a tutorial, or register a warranty for the part, among other examples.

In examples, operator device 108 may obtain vehicle identification information of vehicle 104 and accessory identification information of accessory 106, which may be provided to vehicle platform 102 to associate accessory 106 with an operator profile and/or with vehicle 104 accordingly, among other examples. For example, an operator may have an operator profile associated with vehicle platform 102, which may include operator information (e.g., a name and contact information) and one or more associated vehicles and/or accessories). In some instances, a manual or tutorial associated with accessory 106 is identified based at least in part on vehicle identification information of vehicle 104, as may be obtained by tag reader 130 or as may be associated with an operator account of vehicle platform 102.

System 100 further includes vehicle platform 102. In examples, vehicle platform 102 may include one or more computing devices, servers, cloud computing devices, or the like. As illustrated, vehicle platform 102 includes request processor 114, vehicle information data store 116, experience data store 118, warranty data store 120, and service data store 121.

Request processor 114 may process requests from operator application 128 and management application 132 of operator device 108 and management device 110, respectively. For example, request processor 114 may receive a request for a website associated with a vehicle URL, such that request processor 114 determines, based on the vehicle identification information of the vehicle URL, whether the associated vehicle (e.g., vehicle 104) is registered to an operator.

Accordingly, if request processor 114 determines the vehicle is registered, request processor 114 may provide vehicle-specific information, for example from vehicle information data store 116, in response (e.g., as a website or by redirecting the request to a website comprising the vehicle-specific information). The vehicle-specific website may include vehicle-specific and/or model-specific information associated with the vehicle. In examples, request processor 114 may identify one or more recalls or service bulletins and/or theft alerts, which may be provided as part of the vehicle-specific website. For example, an operator may provide an indication to vehicle platform 102 (e.g., via operator device 108) that a vehicle associated with the operator's profile has been stolen, such that the vehicle-specific website provided by request processor 114 includes a theft alert accordingly. Thus, the vehicle-specific website may enable any of a variety of users to view the theft alert, as may be performed by a prospective buyer or an enforcement officer, among other examples.

In examples, the vehicle-specific website enables an operator of the vehicle to provide authentication information (e.g., a username/password or a one-time PIN) to access additional information and/or functionality. For example, as a result of authenticating with vehicle platform 102, an operator may be able to configure theft alerts, obtain service information associated with the vehicle (e.g., service manuals or safety/service information), schedule service appointments, and/or order parts or accessories for the vehicle, among other examples. Thus, a vehicle-specific website, as may be accessed using information of radio tag 124, may include a set of information that is public (e.g., in instances where a computing device is not authenticated), as well as a set of alternative and/or additional information that is private (e.g., as may be accessible when operator authentication information has been received).

As another example, request processor 114 may determine that the vehicle is not registered, such that request processor 114 instead redirects the request to provide a pre-sales experience according to aspects described herein. For example, the pre-sales experience may include model-specific information (e.g., features that are common to a model of the vehicle, improvements over a past model year, and/or an expected date of availability), customization options, available accessories, and/or pricing and financing information. In some examples, the pre-sales experience includes a 3D model of the vehicle, which may be customizable by the user, for example to include different colors or styles, different options, and/or different vehicle accessories (e.g., accessory 106).

In examples, a user may place an order (e.g., for a vehicle, for an accessory, or for a replacement part) via vehicle platform 102 as a result of the information obtained from vehicle platform 102 using radio tag 124 and/or 126 according to aspects described herein. In response to such an order indication, vehicle platform 102 may process the indication to process the user's order accordingly. For example, the vehicle platform 102 may obtain billing information and/or shipping information based on an associated operator profile, which may be used to process the order.

In some instances, request processor 114 determines to provide an experience website. For example, a request received by request processor 114 from operator application 128 may include an experience URL, as may be stored by radio tag 124. In other examples, vehicle platform 102 may be configured to provide the experience website in response to a request for a vehicle URL of the vehicle, such that radio tag 124 need not be programmed with an experience URL. Thus, the behavior of vehicle platform 102 may be controlled as a result of information stored by radio tag 124 and/or by configuration of vehicle platform 102 itself.

Accordingly, request processor 114 may identify experience information from experience data store 118. For example, the request may include an identifier with which the experience information is identified. In examples where vehicle platform 102 is configured to provide experience information in response to a vehicle URL, the experience information may be identified based at least in part on vehicle identification information of the vehicle URL. As discussed above, the experience website may include trail information, terrain information, and/or safety information. In some examples, the experience website includes interactive safety training and/or document review functionality, such that interactions with a user may be documented and/or stored by vehicle platform 102. As an example, a user may review and execute a waiver via the experience website or may perform a vehicle inspection, for example by capturing images, videos, and/or answering questions or making notes relating to the condition of the vehicle.

Request processor 114 may receive a request to associate an accessory (e.g., accessory 106) with an operator profile and/or a vehicle (e.g., vehicle 104). For example, the request may be received as a result of operator device 108 scanning radio tag 126 of accessory 106 and, in some examples, radio tag 124 of vehicle 104. Thus, the request may include accessory identification information of radio tag 126. In some instances, request processor 114 may update warranty registration information associated with accessory 106, as may be stored by warranty data store 120. As another example, request processor 114 may provide a manual or a tutorial associated with accessory 106 based at least in part on accessory identification information of radio tag 126. Thus, it will be appreciated that any of a variety of functionality may be provided by vehicle platform 102 based on vehicle identification information and/or accessory identification information of radio tags 124 and 126, respectively.

Vehicle platform 102 is further illustrated as comprising service data store 121, which may store one or more service records associated with vehicle 104. For example, request processor 114 may receive a request to create a service record from management application 132 of management device 110. The request may include vehicle identification information that was obtained from radio tag 124 by tag writer 134 of management device 110. Accordingly, a new service record may be generated within service data store 121, as may be associated with the vehicle identification information. It will be appreciated that a service record may similarly be modified or deleted (e.g., by management application 132). In examples, management application 132 provide an indication to order a part for vehicle 104, which may similarly comprise an indication of vehicle identification information from radio tag 124. Example information that may be maintained using a service record includes, but is not limited to, one or more parts that were replaced, one or more services that were performed, and/or an associated part and/or labor cost. As another example, a service record may include a workflow of tasks associated with servicing a vehicle.

In some instances, vehicle identification information may be obtained from multiple components of vehicle 104, such that it may be determined whether the vehicle identification information is accurate. For example, vehicle controller 122 may also have associated vehicle identification information, as may be obtained by management application 132 (e.g., as a result of manual user input or as a result of a connection to vehicle controller 122). Accordingly, the vehicle identification information of vehicle controller 122 may be compared to vehicle identification information of radio tag 124 (e.g., by management device 110 and/or vehicle platform 102). In instances where the vehicle identification information does not match, a conflict may automatically be resolved (e.g., based on a hierarchy of information sources, for example where radio tag 124 is determined to take precedence over vehicle controller 122) or may be resolved based at least in part on user input received by management device 110, among other examples. For example, a mismatch may occur when vehicle controller 122 is from a different vehicle (not pictured).

As a result of maintaining service records in service data store 121, vehicle platform 102 may determine a set of services that were performed with respect to vehicle 104 and/or by a given dealer or vehicle service center, among other examples. In some instances, vehicle platform 102 may make such a determination to provide payment for service performed, for the purposes of warranty reimbursement, or for determining any of a variety of metrics.

While system 100 is described in an example where request processor 114 provides various websites and processes various requests from operator application 128 and management application 132, it will be appreciated that similar techniques may be used in instances where operator application 128 is a native application executing on operator device 108 and/or management application 132 is a web-based application. In some instances, request processor 114 may cause a first subset of requests to be handled by a native application, while a second subset of requests are handled by a web browser. As an example, a vehicle URL associated with a registered vehicle may be redirected to cause a native application of operator device 108 to execute, while a vehicle URL associated with an experience provider may be redirected to an experience website accordingly. It will be appreciated that while examples herein are described with respect to processing performed by operator device 108, management device 110, and/or vehicle platform 102, other examples may include any subset or combination thereof performing similar processing. For example, certain aspects may be performed locally by operator device 108 (e.g., without processing by vehicle platform 102).

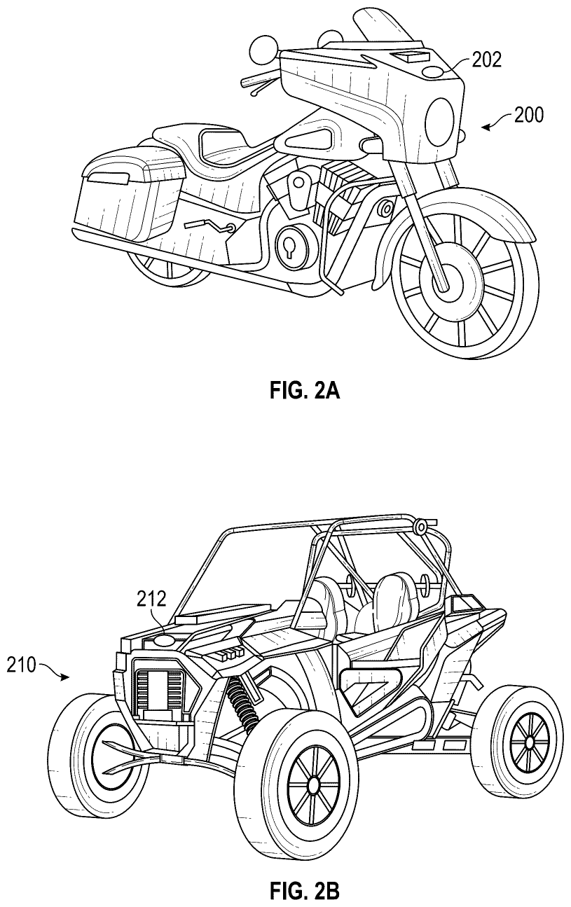

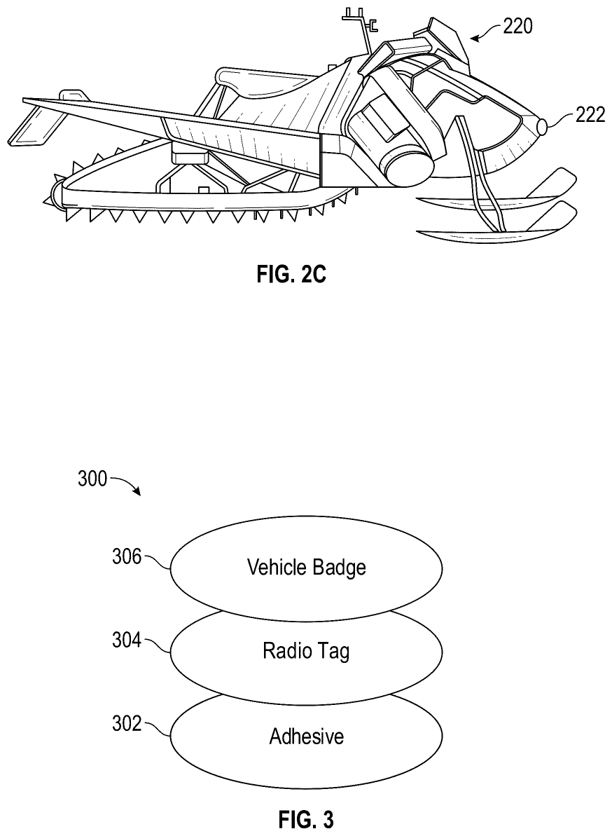

FIGS. 2A-2C illustrate example locations at which a vehicle smart tag may be positioned on a variety of vehicle types. For example, FIG. 2A illustrates an example motorcycle 200, where vehicle smart tag 202 is the front emblem of motorcycle 200. FIGS. 2B and 2C illustrate smart tags 212 and 222 of vehicles 210 and 220, respectively, which are similarly located at the front of each respective vehicle, thereby enabling easy access by an operator, service provider, dealer, or other user. While examples are described herein where a single vehicle smart tag is used, it will be appreciated that, in other examples, multiple radio tags may be affixed to a single vehicle. Further, it will be appreciated that any of a variety of other locations may be used, for example toward the rear of the vehicle or inside an operator area of the vehicle, thereby enabling access to the radio tag when an operator is at the rear of the vehicle or inside the vehicle, respectively.

FIG. 3 illustrates an exploded view of an example vehicle smart tag 300 according to aspects of the present disclosure. As illustrated, vehicle smart tag 300 includes adhesive layer 302, radio tag layer 304, and vehicle badge layer 306. Thus, vehicle smart tag 300 may adhere to a vehicle, for example at one of the locations shown in FIGS. 2A-2C discussed above. Aspects of radio tag layer 304 may be similar to radio tag 124 and/or 126 discussed above with respect to FIG. 1 and are therefore not necessarily re-described in detail below.

Vehicle badge layer 306 may include an icon, logo, or other graphic associated with a vehicle on which smart tag 300 is affixed. For example, vehicle badge layer 306 may be a logo of a manufacturer of the vehicle. In some examples, vehicle badge layer 306 includes a graphical feature that indicates to a user that the badge can be scanned using a tag reader (e.g., tag reader 130 or tag writer 134 discussed above with respect to FIG. 1). In examples, vehicle badge layer 306 (and, in some examples, adhesive layer 302) is larger than radio tag layer 304. As a result, vehicle badge layer 306, in cooperation with the body of a vehicle and/or adhesive layer 302, offers at least some protection to radio tag layer 304 from environmental conditions.

While FIG. 3 depicts an example vehicle smart tag 300, it will be appreciated that similar techniques may be used for an accessory smart tag. Further, it will be appreciated that a variety of alternative or additional techniques may be used to affix radio tag layer 304 to a vehicle, such as one or more rivets or spot welds. As another example, vehicle badge layer 306 may be part of a vehicle chassis (e.g., as may be engraved or etched into the chassis), while radio tag layer 304 may disposed on the inside of the vehicle chassis, thereby protecting radio tag layer 304 from environmental conditions.

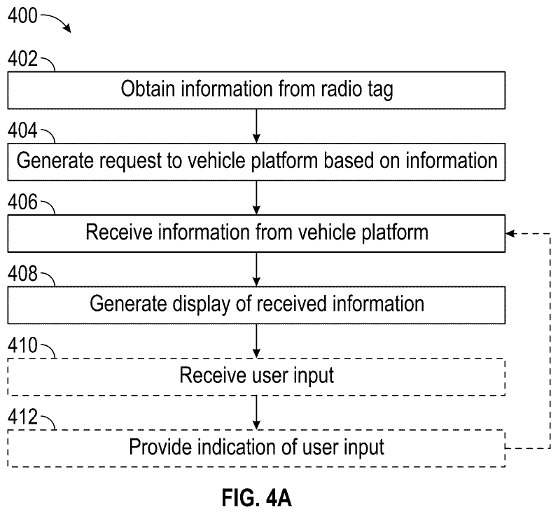

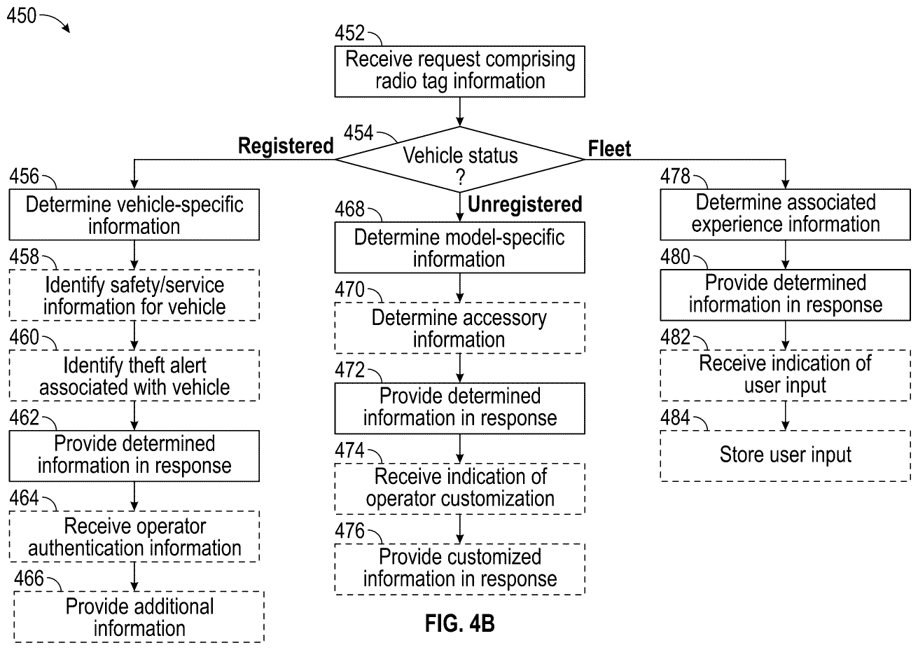

FIG. 4A illustrates an overview of an example method 400 for requesting information associated with a vehicle smart tag according to aspects described herein. In examples, aspects of method 400 are performed by an operator device, such as operator device 108 discussed above with respect to FIG. 1.

Method 400 begins at operation 402, where information is obtained from a radio tag. For example, vehicle identification information may be obtained from a radio tag (e.g., radio tag 124) using a tag reader (e.g., tag reader 130 of operator device 108). In examples, the obtained information is a vehicle URL associated with a vehicle platform, such as vehicle platform 102.

Flow progresses to operation 404, where a request is generated based on the information obtained from the radio tag. For example, operation 404 may comprise accessing the vehicle URL using a web browser application of the operator device (e.g., operator application 128). As another example, the request may be generated by a native application, for example using an application programming interface (API) associated with the vehicle platform. It will be appreciated that the request need not be a vehicle URL and may instead include the vehicle identification information itself.

At operation 406, information is received from the vehicle platform in response to the request that was generated at operation 404. For example, the received information may include vehicle-specific information, model-specific information, and/or experience information, among other examples. In some instances, operations 404 and 406 may comprise following one or more redirects received from the vehicle platform, as may be the case when the vehicle platform determines to redirect the request to a vehicle-specific website, a pre-sales website, or an experience website, among other examples.

At operation 408, a display is generated using the received information. For example, operation 408 may comprise displaying a website that was accessed as a result of operations 404 and 406. In other examples, operation 408 comprises presenting a view of a native application based on the information that was received at operation 406. In some examples, operation 408 comprises displaying a 3D model associated with a vehicle from which the information was obtained and/or one or more associated accessories. In other examples, the information received from the vehicle platform may include a manual or a video tutorial, among other examples. Thus, it will be appreciated that any of a variety of information may be obtained from a vehicle platform and displayed as a result of information obtained from a radio tag. In examples, method 400 terminates at operation 408.

In other examples, flow progresses to operation 410, where user input is received. For example, the received operator input may include operator authentication information, which may be provided at operation 412 to obtain additional information from the vehicle platform. In another example, operation 408 may comprise displaying a waiver or safety training, such that operation 410 comprises receiving user input associated with the wavier or safety training, an indication of which is provided to the vehicle platform at operation 412. As a result, an indication that input was received by the vehicle platform may be displayed at operation 408. As a further example, operation 410 may comprise receiving user input associated with a 3D model, for example to manipulate the 3D model or to change one or more characteristics (e.g., a vehicle color, a factory configuration, and/or selected accessories). In some instances, flow may loop between operations 408 and 410, as may be the case when the safety training is interactive or when a user manipulates a displayed 3D model. Method 400 eventually terminates at operation 408 or 412.

FIG. 4B illustrates an overview of an example method 450 for processing a request for information associated with a vehicle smart tag according to aspects described herein. In examples, aspects of method 450 are performed by a vehicle platform, such as vehicle platform 102 discussed above with respect to FIG. 1.

Method 450 begins at operation 452, where a request including radio tag information is received. For example, the request includes vehicle identification information, as may have been obtained from a radio tag such as radio tag 124 of vehicle 104 discussed above with respect to FIG. 1. In examples, the request is received as a result of an operator device (e.g., operator device 108) accessing a vehicle URL according to aspects described herein.

At determination 454, a vehicle status is determined for the vehicle associated with the received radio tag information. For example, the vehicle status may be determined by looking up vehicle identification information in a vehicle information data store, such as vehicle information data store 116 discussed above with respect to FIG. 1. The vehicle status may change as a result of an operator registering a vehicle to associate the vehicle with a profile of a vehicle platform or as a result of a sale of the vehicle. As another example, an experience provider may update a vehicle status, such that experience information is determined and provided accordingly, as discussed in greater detail below. Thus, it will be appreciated that a vehicle status may be determined using any of a variety of techniques and may be affected as a result of any of a variety of events and/or user input.

If, at determination 454, it is determined that the vehicle status is registered, flow branches “REGISTERED” to operation 456, where vehicle-specific information is determined. For example, the vehicle-specific information may be determined from a vehicle information data store (e.g., vehicle information data store 116) based on vehicle identification information. As discussed above, the vehicle-specific information may include a factory configuration of the vehicle. In some instances, operation 456 further comprises determining model-specific information.

At operation 458, safety/service information may be identified for the vehicle. For example, the safety/service information may be associated with the vehicle identification information or may be more generally associated with a model of the vehicle, among other examples. The safety/service information may include an indication as to one or more actions that may be performed to improve the safety and/or performance of the vehicle, how the vehicle is affected by the service bulletin, the severity of a recall, and/or available service options, among other examples. Operation 458 is illustrated using a dashed box to indicate that, in some examples, safety/service information may not be identified, as may be the case when there is no safety/service information associated with the vehicle.

At operation 460, a theft alert may be identified for the vehicle. For example, the theft alert may be identified as a result of an operator having provided an indication that the vehicle was stolen. The theft alert may be identified based at least in part on vehicle identification information associated with the vehicle. The theft alert information may include an indication as to when the vehicle was reported to be stolen, where the vehicle was last seen, and/or contact information to contact the operator associated with the vehicle or other operator-customizable information. Operation 460 is illustrated using a dashed box to indicate that, in some examples, theft alert information may not be identified, as may be the case when there is no theft alert information associated with the vehicle.

Moving to operation 462, the information determined at operations 456, 458, and/or 460 is provided in response to the request that was received at operation 452. For example, the information may be provided as a website that is displayed by an operator device or may be provided for display by a native application executing on the operator device, among other examples. In examples, method 450 terminates at operation 462.

In other examples, flow progresses to operation 464, where operator authentication information is received. For example, the operator authentication information may be received as a result of an operator device performing aspects of operations 408 and 410 discussed above with respect to method 400. In examples, the operator authentication information comprises a username and password or a one-time PIN (e.g., as may have been sent to an operator device as an electronic communication). It will be appreciated that any of a variety of alternative or additional authentication techniques may be used in other examples.

Flow progresses to operation 466, where additional information is provided. For example, the information provided at operation 462 may be a set of information that is public, whereas the information provided at operation 466 may be information that is private. Method 450 terminates at operation 466.

Returning to determination 454, if it is instead determined that the vehicle is unregistered, flow branches “UNREGISTERED” to operation 468, where model-specific information is determined. The model-specific information may be determined based at least in part on the radio tag information that was received at operation 452. For example, the model-specific information may include information associated with a model year of the vehicle, available options, purchase information, and/or financing information. In examples, the determined model-specific information at operation 468 includes one or more 3D models, as may be used to help a prospective buyer visualize the vehicle.

Flow progresses to operation 470, where accessory information may be determined. For example, the determined accessory information may be for accessories that are compatible with the vehicle and/or available for purchase, among other examples. In some instances, the accessory information that is determined at operation 470 includes one or more 3D models, as may be used to help a prospective buyer visualize the accessories (e.g., in combination with or separate from a 3D vehicle model, as may have been determined at operation 468). Operation 470 is illustrated using a dashed box to indicate that, in some examples, operation 470 may be omitted.

At operation 472, the determined information is provided in response to the request that was received at operation 452. For example, the information may be provided as a website that is displayed by an operator device or may be provided for display by a native application executing on the operator device, among other examples. In examples, method 450 terminates at operation 472.

In other examples, flow progresses to operation 474, where an indication of operator customization is received. For example, the indication may comprise a selection of different colors or styles, different options, and/or different vehicle accessories, among other examples. Accordingly, at operation 476, customized information is provided in response. For example, the customized information may comprise one or more different 3D models, updated pricing and/or financing information, or updated availability information. Method 450 terminates at operation 476.

Returning to determination 454, if it is instead determined that the vehicle is part of a fleet (e.g., of an experience provider or of a dealer), flow branches “FLEET” to operation 478, where experience information associated with the fleet is determined. For example, the experience information may be determined based at least in part on the received radio tag information. As discussed above, the request received at operation 452 may be received as a result of an operator device accessing an experience URL stored by a radio tag. In other examples, a vehicle platform may be configured to provide experience information based at least in part on vehicle identification information (e.g., of a vehicle URL). The experience information determined at operation 478 may include, but is not limited to, trail information, terrain information, and/or safety information.

At operation 480, the determined information is provided in response to the request that was received at operation 452. For example, the information may be provided as a website that is displayed by an operator device or may be provided for display by a native application executing on the operator device, among other examples. In examples, method 450 terminates at operation 480.

In other examples, flow progresses to operation 482, where an indication of user input is received. For example, the indication of user input may be received as a result of an operator device performing aspects of operations 408 and 410 discussed above with respect to FIG. 4A, as may be the case when the provided experience information includes interactive safety training and/or a waiver for user review and execution. Accordingly, the indication of user input received at operation 482 may be stored at operation 484, thereby enabling later review and/or retrieval of the received user input. In some instances, operation 484 further comprises generating an indication that user input has been received, as may be provided to an experience provider accordingly. As another example, operations 482-484 may comprise receiving an indication of a condition of a vehicle, as may include image and/or video data, as well as an indication of specific damage to the vehicle, among other examples. Method 450 terminates at operation 484.

It will be appreciated that, while method 450 has been described in examples where information is identified and provided as a result of 456-466, 468-476, and 478-480, other examples may comprise providing an indication to redirect an operator device to a different website or a third party from which similar information may be obtained. Further, while method 450 is described in instances where operations are performed sequentially, it will be appreciated that aspects of method 450 may be performed repeatedly (e.g., operations 464-466, 474-476, and 482-484).

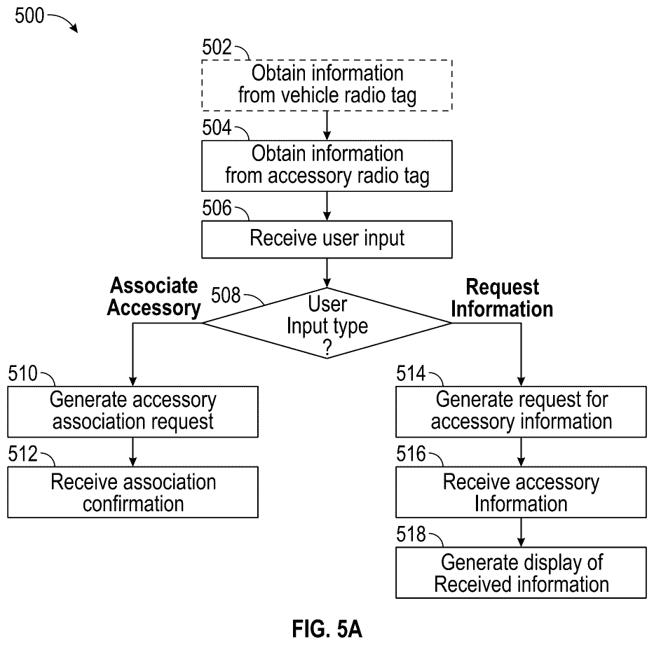

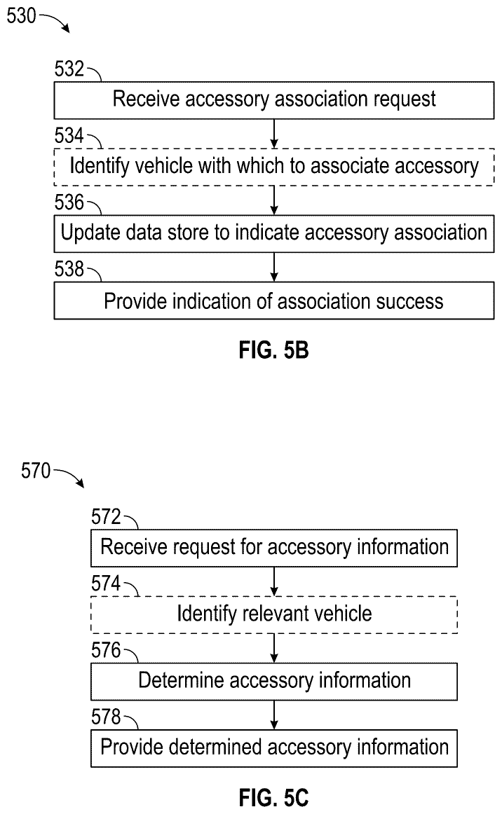

FIG. 5A illustrates an overview of an example method 500 for processing accessory radio tag information according to aspects described herein. In examples, method 500 is performed by an operator device, such as operator device 108 discussed above with respect to FIG. 1.

Method 500 may begin at operation 502, where information is obtained from a vehicle radio tag, such as radio tag 124 of vehicle 104 in FIG. 1. For example, the information may be obtained by scanning the vehicle radio tag using a tag reader, such as tag reader 130 or tag writer 134. The obtained information may include vehicle identification information. Operation 502 is illustrated using a dashed box to indicate that, in other examples, method 500 begins at operation 504. For example, operation 502 may be omitted in instances where a vehicle is already associated with an operator profile at a vehicle platform or when vehicle identification information is not used to perform aspects of method 500.

At operation 504, information is obtained from an accessory radio tag, such as radio tag 126 of accessory 106 in FIG. 1. For example, the information may be obtained by scanning the accessory radio tag using a tag reader. The obtained information may include accessory identification information.

Flow progresses to operation 506, where user input is received. For example, the user input may include an indication to associate the accessory with a vehicle and/or with an operator profile or to request information associated with the accessory. While method 500 is illustrated in an example where user input is received subsequent to obtaining the vehicle identification information and/or the accessory identification information, it will be appreciated that such user input may be received prior to one or both of operations 502 and 504 in other examples.

At determination 508, the type of user input is determined. If it is determined that the user input is to associate the accessory, flow branches “ASSOCIATE ACCESSORY” to operation 510, where an accessory association request is generated. For example, the accessory association request may comprise at least a part of the information that was obtained at operation 504 (and, in some examples, operation 502). In an example, the accessory association request may include an indication of an operator, such that an operator profile with which to associate the accessory may be identified.

The accessory association request is provided to a vehicle platform (e.g., vehicle platform 102), such that an association confirmation is received at operation 512. For example, the association confirmation may include an indication that the accessory was successfully registered with an operator profile and/or a vehicle. In some instances, the accessory association request may cause warranty registration to be performed, such that operation 512 comprises an indication that a warranty of the accessory was successfully registered. Method 500 terminates at operation 512.

Returning to determination 508, if it is instead determined that the user input is to request information, flow branches “REQUEST INFORMATION” to operation 514, where a request for accessory information is generated. For example, the request for accessory information may include at least a part of the information that was obtained at operation 504 (and, in some examples, operation 502).

The accessory association request is provided to a vehicle platform (e.g., vehicle platform 102), such that accessory information is received in response at operation 516. Example accessory information includes, but is not limited to, an indication of a manual associated with the accessory, an indication of a tutorial associated with the accessory, or accessory service options, among other examples. In examples, the accessory information may be dependent on a vehicle, as may be indicated as a result of information obtained from a vehicle radio tag or may be determined as a result of a vehicle associated with an operator profile. For example, a different manual may be provided for an accessory if it is associated with a first vehicle as compared to a second vehicle. In some instances, operation 516 comprises receiving the manual or tutorial itself or, as another example, operation 516 may receive a URL associated with the manual or tutorial, such that the URL may be accessed accordingly.

The accessory information is used to generate a display at operation 518. For example, the manual or tutorial may be presented to an operator. Method 500 terminates at operation 518.

FIGS. 5B and 5C illustrate overviews of example methods 530 and 570 for processing requests associated with accessory radio tag information according to aspects described herein. For example, methods 530 and 570 may be performed by a vehicle platform, such as vehicle platform 102. In examples, method 530 and 570 may be performed in response to an operator device performing aspects of method 500 discussed above with respect to FIG. 5A.

With reference to FIG. 5B, method 530 begins at operation 532, where an accessory association request is received. In examples, the accessory association request includes accessory identification information and, in some examples, vehicle identification information. For example, such identification information may have been obtained from an accessory radio tag and a vehicle radio tag. The accessory association request may be received from an operator device (e.g., operator device 108 in FIG. 1) performing aspects of method 500 discussed above with respect to FIG. 5A.

At operation 534, a vehicle is identified with which to associate the accessory. Operation 534 is illustrated using a dashed box to indicate that, in some examples, operation 534 may be omitted. For example, in instances where the accessory association request includes vehicle identification information, operation 534 may be omitted. Similarly, if an accessory is to be associated with an operator profile but not a specific vehicle, operation 534 may be omitted. By contrast, if vehicle identification information is not received at operation 532, a vehicle may be identified based on an association with an operator profile.

At operation 536, a data store is updated to indicate an association of the accessory with an operator profile and/or a given vehicle. For example, a vehicle information data store may be updated, such as vehicle information data store 116 of vehicle platform 102 in FIG. 1. While examples are described where an accessory is associated with a single operator profile and/or a single vehicle, it will be appreciated that similar techniques may be used to associate an accessory with any number of these or other entities. Similarly, while method 530 is described in the context of an accessory association request, it will be appreciated that similar techniques may be used to associate a vehicle with an operator profile.

At operation 538, an indication of association success is provided. In some instances, operation 536 may comprise registering a warranty associated with the accessory or updating other warranty information (e.g., as may be stored by a warranty data store, such as warranty data store 120 of vehicle platform 102), in which case the indication of association success may include an indication that the warranty of the accessory was successfully registered. Method 530 terminates at operation 538.

Turning now to FIG. 5C, method 570 begins at operation 572, where a request for accessory information is received. In some examples, the request includes accessory identification information and/or vehicle identification information. For example, such identification information may have been obtained from an accessory radio tag and a vehicle radio tag. The request may be received from an operator device (e.g., operator device 108 in FIG. 1) performing aspects of method 500 discussed above with respect to FIG. 5A.

At operation 574, a vehicle is identified with which accessory information may be determined. Operation 574 is illustrated using a dashed box to indicate that, in some examples, operation 574 may be omitted. For example, in instances where the request includes vehicle identification information, operation 574 may be omitted. Similarly, if accessory information is not dependent or otherwise associated with a specific vehicle, operation 574 may be omitted. By contrast, if vehicle identification information is not received at operation 572, a vehicle may be identified based on an association with an operator profile in some examples.

Flow progresses to operation 576, where accessory information is determined. Example accessory information includes, but is not limited to, a manual associated with the accessory, a tutorial associated with the accessory, or accessory service options, among other examples. As noted above, the accessory information may be dependent on a vehicle, as may be determined based on information received as part of the request at operation 572 or the vehicle that was identified at operation 574. For example, a different manual may be determined in association with a first vehicle as compared to a second vehicle.

Flow progresses to operation 578, where the determined accessory information is provided. In examples, operation 578 includes providing the determined accessory information itself, or providing an indication to redirect the request that was received at operation 572 to a URL associated with the determined accessory information, such that the URL may be accessed accordingly. Method 570 terminates at operation 578.

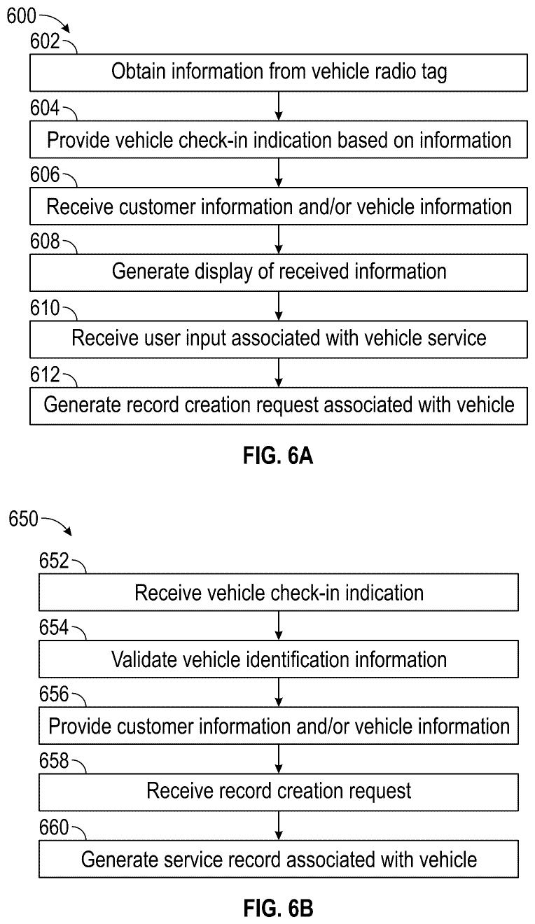

FIG. 6A illustrates an overview of an example method 600 for processing vehicle radio tag information in a vehicle service context according to aspects described herein. In examples, aspects of method 600 are performed by a management device, such as management device 110 discussed above with respect to FIG. 1.

Method 600 begins at operation 602, where information is obtained from a vehicle radio tag, such as radio tag 124 of vehicle 104 in FIG. 1. For example, the information may be obtained by scanning the vehicle radio tag using a tag reader, such as tag reader 130 or tag writer 134. The obtained information may include vehicle identification information. In examples, operation 602 obtains an entry of a radio tag that is a vehicle URL or that includes only vehicle identification information, among other examples. As another example, operation 602 includes identifying vehicle identification information from a vehicle URL and using the identified vehicle identification information accordingly.

At operation 604, a vehicle check-in indication is provided based on the information obtained from the vehicle radio tag. For example, the vehicle check-in indication may include the vehicle identification information and any of a variety of other information associated with the vehicle that may be obtained at operation 602, including, but not limited to, one or more photos or videos, or information obtained from other components of the vehicle (e.g., vehicle controller 122).

At operation 606, customer information (which may also be referred to herein as operator information) and/or vehicle information is received in response to the provided check-in indication. For example, the received information may include one or more tasks that are to be performed to service the vehicle, available parts to be used or ordered, customer contact information, and/or past service that has been performed on the vehicle, among other information. At least a part of the received information is displayed at operation 608, which may be used by a user of the management device to update the information, add new information, or confirm the correctness of the information, among other examples.

Accordingly, user input is received at operation 610. For example, the user input may include revisions to the received information, an indication to capture one or more images or videos, a selection of one or more parts to be used in servicing the vehicle, or confirmation that the received information is correct, among other examples.

Flow progresses to operation 612, where a record creation request is generated. For example, the record creation request is based at least in part on the user input received at operation 610 and may include an indication that the received information is correct, one or more updates to the received information, and/or a selection of one or more parts to use in servicing the vehicle, among other examples. While method 600 is described in an example where a service record is created, it will be appreciated that similar techniques may be used to update a service record. Further, similar techniques may be used to check-in a vehicle in the absence of existing information maintained by the vehicle platform (e.g., for a walk-in service appointment), for example where aspects similar to operations 604 and 606 are instead included as part of operation 612. Method 600 terminates at operation 612.

FIG. 6B illustrates an overview of an example method 650 for generating a service record based on vehicle radio tag information. In examples, aspects of method 650 are performed by a vehicle platform, such as vehicle platform 102 discussed above with respect to FIG. 1.

Method 650 begins at operation 652, where a vehicle check-in indication is received. For example, the vehicle check-in indication may be received from a management device (e.g., management device 110) performing aspects of method 600 discussed above with respect to FIG. 6A. As an example, the check-in indication may include vehicle identification information and any of a variety of other information associated with a vehicle, such as one or more photos or videos, or information obtained from other components of the vehicle.

At operation 654, vehicle identification information is validated. For example, the check-in indication received at operation 652 may include vehicle identification information from multiple sources, such as a radio tag and a vehicle controller of the vehicle. Accordingly, operation 654 may determine whether the vehicle identification information from the multiple sources match. In instances where the vehicle identification information does not match, a conflict may automatically be resolved (e.g., based on a hierarchy of sources, for example where a radio tag is determined to take precedence over a vehicle controller) or may be resolved based at least in part on manual user input (e.g., as may be requested from a management device).

Moving to operation 656, customer information and/or vehicle information is provided in response to the check-in indication. For example, the information may be identified based on the validated vehicle identification information. Thus, as a result of validating the vehicle identification information, the information provided at operation 656 may be more accurate than would otherwise be the case. Even so, in other examples, operation 654 may be omitted. At least a part of the information may be identified from a vehicle information data store, such as vehicle information data store 116 in FIG. 1. In some instances, the customer information is determined from an operator profile, as may be associated with an operator of the vehicle. The provided information may include one or more parts that may be used to service the vehicle.

Flow progresses to operation 658, where a record creation request is received. For example, the record creation request may be received as a result of a management device performing aspects of operations 608-612 discussed above with respect to method 600 in FIG. 6A. The record creation request may include additional vehicle information (e.g., as may have been provided by a user via a management device), an indication that information provided at operation 656 has been confirmed, or a selection of one or more parts to be used to service the vehicle, among other examples.

Flow progresses to operation 660, where a service record is generated and associated with the vehicle. For example, the service record may include information that was received as part of the record creation request at operation 658. The service record may be created in a service data store, such as service data store 121 in FIG. 1. In some examples, the service record is stored in association with vehicle identification information and/or an operator profile, among other examples. While method 650 is described in an example where a service record is generated, it will be appreciated that similar techniques may be used to update a service record in a service data store. Method 650 terminates at operation 660.

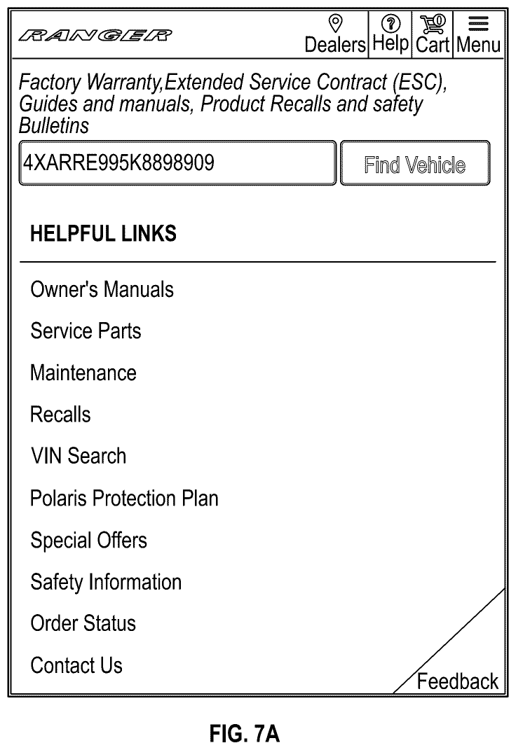

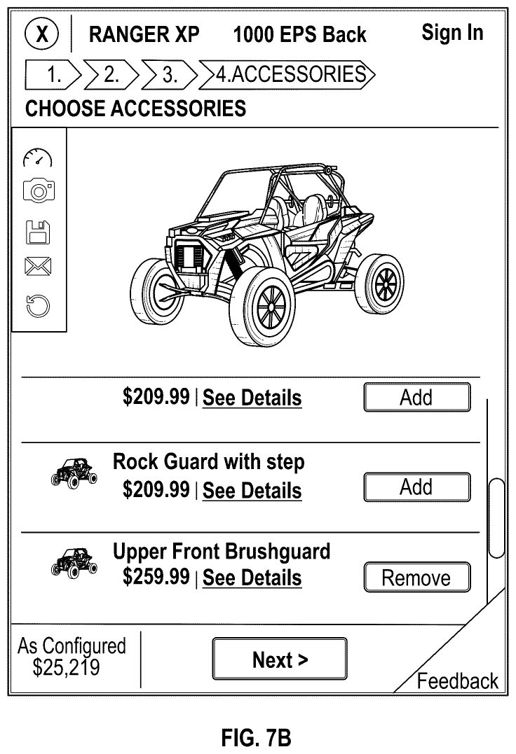

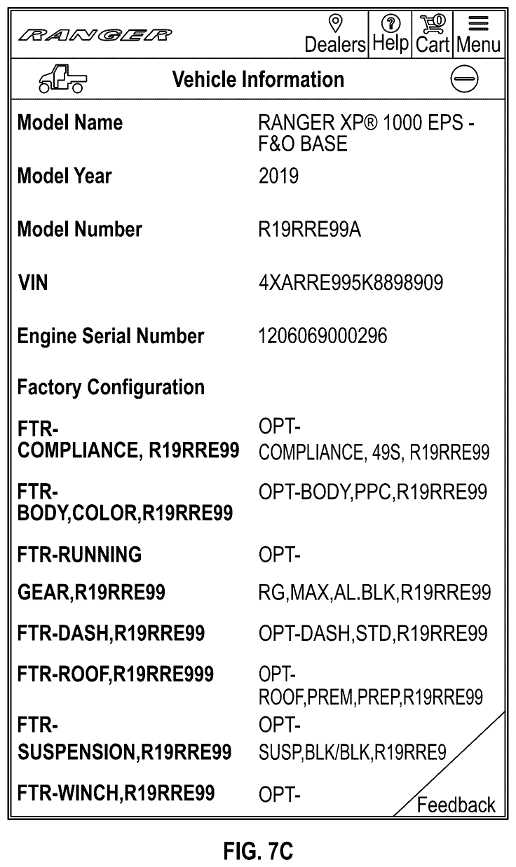

FIGS. 7A-7C illustrate overviews of example user interfaces according to aspects described herein. For example, such user interfaces may be presented at an operator device (e.g., operator device 108 in FIG. 1) as a result of accessing a vehicle URL or otherwise scanning a vehicle radio tag according to aspects described herein. For example, FIG. 7A illustrates an example of various functionality that may be available as a result of providing vehicle identification information, including, but not limited to, accessing owner's manuals, ordering parts, scheduling service, and viewing relevant safety/service information. FIG. 7B illustrates an example pre-sales experience, where a user is presented with a 3D model of a vehicle, available accessories, and associated pricing information. FIG. 7C illustrates an example vehicle-specific website, where vehicle-specific information is presented, where factory configuration information is presented.

It will be appreciated that aspects discussed above are provided as example functionality that may be implemented using vehicle and/or accessory radio tags, for example in conjunction with an operator device, a management device, and/or a vehicle platform. Any of a variety of other functionality may similarly be provided, for example to provide other aspects relating to a Pre-Ownership User Experience, an Ownership User Experience, a Fleet Owner Or Rental Franchise User Experience, or a Dealer User Experience.

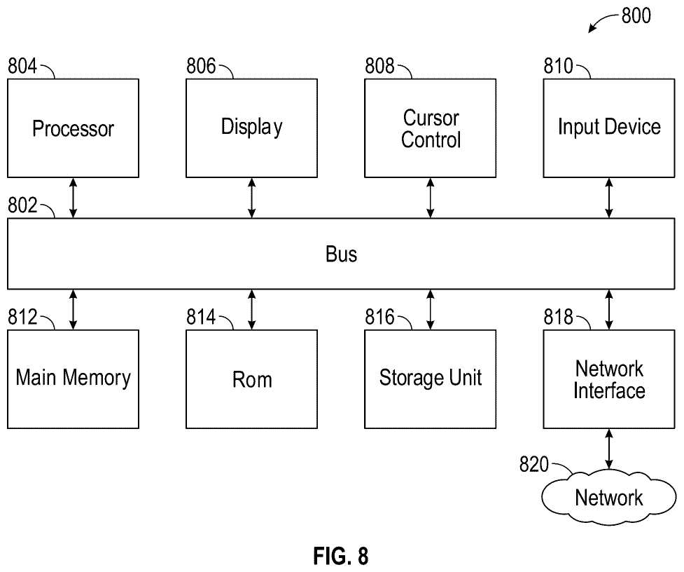

FIG. 8 illustrates a diagram of a computing system 800 for multi-vehicle communication and control. For example, some or all of the functions of vehicle platform 102, operator device 108, management device 110, and/or vehicle controller 122 may be performed by one or more computing systems that has similar components as the computing system 800. This diagram is merely an example, which should not unduly limit the scope of the claims. One of ordinary skill in the art would recognize many variations, alternatives, and modifications.

The computing system 800 includes a bus 802 or other communication mechanism for communicating information between, a processor 804, a display 806, a cursor control component 808, an input device 810, a main memory 812, a read only memory (ROM) 814, a storage unit 816, and/or a network interface 818. In examples, such memory is a non-transitory computer-readable storage medium. In some examples, the bus 802 is coupled to the processor 804, the display 806, the cursor control component 808, the input device 810, the main memory 812, the read only memory (ROM) 814, the storage unit 816, and/or the network interface 818. And, in certain examples, the network interface 818 is coupled to a network 820 (e.g., the network 112).

In some examples, the processor 804 includes one or more general purpose microprocessors. In some examples, the main memory 812 (e.g., random access memory (RAM), cache and/or other dynamic storage devices) is configured to store information and instructions to be executed by the processor 804. In certain examples, the main memory 812 is configured to store temporary variables or other intermediate information during execution of instructions to be executed by processor 804. For example, the instructions, when stored in the storage unit 816 accessible to processor 804, render the computing system 800 into a special-purpose machine that is customized to perform the operations specified in the instructions. In some examples, the ROM 814 is configured to store static information and instructions for the processor 804. In certain examples, the storage unit 816 (e.g., a magnetic disk, optical disk, or flash drive) is configured to store information and instructions.

Thus, computing system 800 may include at least some form of computer readable media. The computer readable media may be any available media that can be accessed by processor 804 or other devices. For example, the computer readable media may include computer storage media and communication media. The computer storage media may include volatile and nonvolatile, removable and non-removable media, and/or non-transitory media implemented in any method or technology for storage of information such as computer readable instructions, data structures, program modules or other data. The computer storage media may not include communication media.

In some embodiments, the display 806 (e.g., a cathode ray tube (CRT), an LCD display, or a touch screen) is configured to display information to a user of the computing system 800. In some examples, the input device 810 (e.g., alphanumeric and other keys) is configured to communicate information and commands to the processor 804. For example, the cursor control 808 (e.g., a mouse, a trackball, or cursor direction keys) is configured to communicate additional information and commands (e.g., to control cursor movements on the display 806) to the processor 804.

As will be understood from the foregoing disclosure, one aspect of the technology relates to a system comprising: at least one processor; and memory storing instructions that, when executed by the at least one processor, causes the system to perform a set of operations. The set of operations comprises: receiving, from a computing device, an indication of vehicle identification information associated with a radio tag of a vehicle; determining, based on the vehicle identification information, a set of parts associated with the vehicle; providing, in response to the received indication, the determined set of parts; receiving, from the computing device, a user selection of one or more parts from the set of parts; and generating a service record associated with the vehicle, wherein the service record includes an indication of the one or more parts selected by the user. In an example, the set of operations further comprises determining, based on the vehicle identification information, operator information from an operator profile for an operator associated with the vehicle; and providing the determined set of parts further comprises providing the determined operator information. In another example, the set of operations further comprises determining, based on the vehicle identification information, vehicle information; and providing the determined set of parts further comprises providing the determined vehicle information. In a further example, the determined vehicle information includes at least one of a factory configuration of the vehicle or a service manual associated with the vehicle. In yet another example, the set of operations further comprises: determining, based on the vehicle identification information, a set of accessories associated with the vehicle; receiving, from the computing device, a user selection of an accessory of the set of accessories; and generating an order for the accessory based on an operator profile associated with the vehicle. In a further still example, the set of operations further comprises: receiving, from the computing device, an image or video associated with the vehicle; and storing the image or the video in association with the generated service record. In another example, the vehicle identification information is a vehicle identification number.

In another aspect, the technology relates to a method for processing accessory identification information associated with an accessory of a vehicle. The method comprises: receiving, from a computing device of an operator, an indication of the accessory identification information associated with a radio tag of the accessory; determining a vehicle associated with the operator; generating, in a vehicle information data store, an association between the determined vehicle and the accessory based on the accessory identification information; and providing, to the computing device, an indication that the accessory and the vehicle have been associated. In an example, determining the vehicle associated with the operator comprises receiving, from the computing device, an indication of vehicle identification information associated with a radio tag of the vehicle. In another example, determining the vehicle associated with the operator comprises accessing an operator profile associated with the operator. In a further example, providing the indication that the accessory and the vehicle have been associated further comprises providing accessory information associated with the accessory. In yet another example, the accessory information is a manual or a video tutorial. In a further still example, the accessory information is determined based at least in part on the determined vehicle.

In a further aspect, the technology relates to a method for processing accessory identification information associated with an accessory of a vehicle. The method comprises: obtaining, at a computing device, the accessory identification information from a radio tag of the accessory; providing, to a vehicle platform, the obtained accessory identification information; and receiving, from the vehicle platform, accessory information associated with the accessory of the vehicle. In an example, the method further comprises: obtaining, at the computing device, vehicle identification information from a radio tag of the vehicle; and providing, to the vehicle platform, the obtained vehicle identification information. In another example, the received accessory information is associated with the obtained vehicle identification information. In a further example, the accessory identification information and the vehicle identification information are provided to the vehicle platform as an accessory association request. In yet another example, the accessory information includes an indication of a manual or a video tutorial associated with the accessory. In a further still example, the obtained accessory identification information is part of a uniform resource locator (URL) associated with the vehicle platform that is stored by the radio tag of the accessory; and providing the obtained accessory identification information comprises accessing the URL using a browser application of the computing device.

In another aspect, the technology relates to a method for obtaining vehicle information associated with a vehicle. The method comprises: obtaining, at a computing device, vehicle identification information from a radio tag of the vehicle; providing, to a vehicle platform, an indication of the vehicle identification information; receiving, from the vehicle platform, the vehicle information including: a three-dimensional model associated with the vehicle; a set of model options; and a set of available accessories; and generating a display of at least a part of the vehicle information, the display including the three-dimensional model. In an example, the method further comprises: receiving user input associated with at least one of the set of model options or the set of available accessories; and updating the three-dimensional model based on the received user input. In another example, providing the indication of the vehicle identification information comprises accessing, using a browser of the computing device, a uniform resource locator (URL) including the vehicle identification information.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The following clauses are provided as example aspects of the disclosed subject matter:

1. A system comprising: at least one processor; and memory storing instructions that, when executed by the at least one processor, causes the system to perform a set of operations, the set of operations comprising: receiving, from a computing device, an indication of vehicle identification information associated with a radio tag of a vehicle; determining, based on the vehicle identification information, a set of parts associated with the vehicle; providing, in response to the received indication, the determined set of parts; receiving, from the computing device, a user selection of one or more parts from the set of parts; and generating a service record associated with the vehicle, wherein the service record includes an indication of the one or more parts selected by the user.

2. The system of clause 1, wherein: the set of operations further comprises determining, based on the vehicle identification information, operator information from an operator profile for an operator associated with the vehicle; and providing the determined set of parts further comprises providing the determined operator information.

3. The system of any one of clauses 1-2, wherein: the set of operations further comprises determining, based on the vehicle identification information, vehicle information; and providing the determined set of parts further comprises providing the determined vehicle information.

4. The system of clause 3, wherein the determined vehicle information includes at least one of a factory configuration of the vehicle or a service manual associated with the vehicle.

5. The system of any one of clauses 1-4, wherein the set of operations further comprises: determining, based on the vehicle identification information, a set of accessories associated with the vehicle; receiving, from the computing device, a user selection of an accessory of the set of accessories; and generating an order for the accessory based on an operator profile associated with the vehicle.

6. The system of any one of clauses 1-5, wherein the set of operations further comprises: receiving, from the computing device, an image or video associated with the vehicle; and storing the image or the video in association with the generated service record.

7. The system of any one of clauses 1-6, wherein the vehicle identification information is a vehicle identification number.

8. A method for processing accessory identification information associated with an accessory of a vehicle, the method comprising: receiving, from a computing device of an operator, an indication of the accessory identification information associated with a radio tag of the accessory; determining a vehicle associated with the operator; generating, in a vehicle information data store, an association between the determined vehicle and the accessory based on the accessory identification information; and providing, to the computing device, an indication that the accessory and the vehicle have been associated.

9. The method of clause 8, wherein determining the vehicle associated with the operator comprises receiving, from the computing device, an indication of vehicle identification information associated with a radio tag of the vehicle.

10. The method of any one of clauses 8-9, wherein determining the vehicle associated with the operator comprises accessing an operator profile associated with the operator.

11. The method of any one of clauses 8-10, wherein providing the indication that the accessory and the vehicle have been associated further comprises providing accessory information associated with the accessory.

12. The method of clause 11, wherein the accessory information is a manual or a video tutorial.

13. The method of clause 11, wherein the accessory information is determined based at least in part on the determined vehicle.

14. A method for processing accessory identification information associated with an accessory of a vehicle, the method comprising: obtaining, at a computing device, the accessory identification information from a radio tag of the accessory; providing, to a vehicle platform, the obtained accessory identification information; and receiving, from the vehicle platform, accessory information associated with the accessory of the vehicle.

15. The method of clause 14, further comprising: obtaining, at the computing device, vehicle identification information from a radio tag of the vehicle; and providing, to the vehicle platform, the obtained vehicle identification information.

16. The method of clause 15, wherein the received accessory information is associated with the obtained vehicle identification information.

17. The method of any one of clauses 15-16, wherein the accessory identification information and the vehicle identification information are provided to the vehicle platform as an accessory association request.

18. The method of any one of clauses 14-17, wherein the accessory information includes an indication of a manual or a video tutorial associated with the accessory.

19. The method of any one of clauses 14-18, wherein: the obtained accessory identification information is part of a uniform resource locator (URL) associated with the vehicle platform that is stored by the radio tag of the accessory; and providing the obtained accessory identification information comprises accessing the URL using a browser application of the computing device.

20. A method for obtaining vehicle information associated with a vehicle, the method comprising: obtaining, at a computing device, vehicle identification information from a radio tag of the vehicle; providing, to a vehicle platform, an indication of the vehicle identification information; receiving, from the vehicle platform, the vehicle information including: a three-dimensional model associated with the vehicle; a set of model options; and a set of available accessories; and generating a display of at least a part of the vehicle information, the display including the three-dimensional model.

21. The method of clause 20, further comprising: receiving user input associated with at least one of the set of model options or the set of available accessories; and updating the three-dimensional model based on the received user input.

22. The method of any one of clauses 20-21, wherein providing the indication of the vehicle identification information comprises accessing, using a browser of the computing device, a uniform resource locator (URL) including the vehicle identification information.

1. A system comprising:
at least one processor; and
memory storing instructions that, when executed by the at least one processor, causes the system to perform a set of operations, the set of operations comprising:
receiving, from a computing device, an indication of vehicle identification information associated with a radio tag of a vehicle;
determining, based on the vehicle identification information, a set of parts associated with the vehicle;
providing, in response to the received indication, the determined set of parts;
receiving, from the computing device, a user selection of one or more parts from the set of parts; and
generating a service record associated with the vehicle, wherein the service record includes an indication of the one or more parts selected by the user.

2. The system of claim 1, wherein:
the set of operations further comprises determining, based on the vehicle identification information, operator information from an operator profile for an operator associated with the vehicle; and
providing the determined set of parts further comprises providing the determined operator information.

3. The system of claim 1, wherein:
the set of operations further comprises determining, based on the vehicle identification information, vehicle information; and
providing the determined set of parts further comprises providing the determined vehicle information.

4. The system of claim 3, wherein the determined vehicle information includes at least one of a factory configuration of the vehicle or a service manual associated with the vehicle.

5. The system of claim 1, wherein the set of operations further comprises:
determining, based on the vehicle identification information, a set of accessories associated with the vehicle;
receiving, from the computing device, a user selection of an accessory of the set of accessories; and
generating an order for the accessory based on an operator profile associated with the vehicle.

6. The system of claim 1, wherein the set of operations further comprises:
receiving, from the computing device, an image or video associated with the vehicle; and
storing the image or the video in association with the generated service record.

7. The system of claim 1, wherein the vehicle identification information is a vehicle identification number.

8. A method for processing accessory identification information associated with an accessory of a vehicle, the method comprising:
receiving, from a computing device of an operator, an indication of the accessory identification information associated with a radio tag of the accessory;
determining a vehicle associated with the operator;
generating, in a vehicle information data store, an association between the determined vehicle and the accessory based on the accessory identification information; and
providing, to the computing device, an indication that the accessory and the vehicle have been associated.

9. The method of claim 8, wherein determining the vehicle associated with the operator comprises receiving, from the computing device, an indication of vehicle identification information associated with a radio tag of the vehicle.

10. The method of claim 8, wherein determining the vehicle associated with the operator comprises accessing an operator profile associated with the operator.

11. The method of claim 8, wherein providing the indication that the accessory and the vehicle have been associated further comprises providing accessory information associated with the accessory.

12. The method of claim 11, wherein the accessory information is a manual or a video tutorial.

13. The method of claim 11, wherein the accessory information is determined based at least in part on the determined vehicle.

14. A method for processing accessory identification information associated with an accessory of a vehicle, the method comprising:
obtaining, at a computing device, the accessory identification information from a radio tag of the accessory;
providing, to a vehicle platform, the obtained accessory identification information; and
receiving, from the vehicle platform, accessory information associated with the accessory of the vehicle.

15. The method of claim 14, further comprising:
obtaining, at the computing device, vehicle identification information from a radio tag of the vehicle; and
providing, to the vehicle platform, the obtained vehicle identification information.

16. The method of claim 15, wherein the received accessory information is associated with the obtained vehicle identification information.

17. The method of claim 15, wherein the accessory identification information and the vehicle identification information are provided to the vehicle platform as an accessory association request.

18. The method of claim 14, wherein the accessory information includes an indication of a manual or a video tutorial associated with the accessory.

19. The method of claim 14, wherein:
the obtained accessory identification information is part of a uniform resource locator (URL) associated with the vehicle platform that is stored by the radio tag of the accessory; and
providing the obtained accessory identification information comprises accessing the URL using a browser application of the computing device.

20. A method for obtaining vehicle information associated with a vehicle, the method comprising:
obtaining, at a computing device, vehicle identification information from a radio tag of the vehicle;
providing, to a vehicle platform, an indication of the vehicle identification information;
receiving, from the vehicle platform, the vehicle information including:
a three-dimensional model associated with the vehicle;
a set of model options; and
a set of available accessories; and
generating a display of at least a part of the vehicle information, the display including the three-dimensional model.

21. The method of claim 20, further comprising:
receiving user input associated with at least one of the set of model options or the set of available accessories; and
updating the three-dimensional model based on the received user input.

22. The method of claim 20, wherein providing the indication of the vehicle identification information comprises accessing, using a browser of the computing device, a uniform resource locator (URL) including the vehicle identification information.
